(19) United States
(12) Patent Application Publication
(10) Pub. No.: US 2026/0155873 A1
(43) Pub. Date: Jun. 4, 2026

(54) METHOD AND APPARATUS FOR PROCESSING APERIODIC CHANNEL STATE INFORMATION REPORTING REQUEST

(71) Applicant: Electronics and Telecommunications Research Institute, Daejeon (KR)

(72) Inventors: Kyung Sook KIM, Daejeon (KR); Jee Hyeon NA, Daejeon (KR)

(21) Appl. No.: 19/401,967

(22) Filed: Nov. 26, 2025

(30) Foreign Application Priority Data
Nov. 29, 2024 (KR) 10-2024-0175607
Jun. 18, 2025 (KR) 10-2025-0080229

(51) Int. Cl. H04B 7/06; H04W 72/232

(52) U.S. Cl. CPC H04B 7/0626; H04W 72/232

(57) ABSTRACT

A method and apparatus for processing aperiodic channel state information reporting request. An aspect of the present disclosure provides a method for processing an aperiodic channel state information (CSI) reporting request supporting carrier aggregation, performed by a base station, the method comprising: generating, for each carrier configured for a UE, a carrier-specific trigger state list including one or more trigger states associated with each carrier; identifying trigger states in which all associated carriers are in an active state as first trigger states, among trigger states included in a carrier-specific trigger state list of a carrier being a target of aperiodic channel state information reporting request; determining, among the first trigger states, a trigger state having a maximum number of associated carriers as a second trigger state; and setting the second trigger state in a CSI request field of downlink control information and transmitting the downlink control information to the UE.

### CROSS-REFERENCE TO RELATED APPLICATIONS

This application claims priority from Korean Patent Application No. 10-2024-0175607, filed on Nov. 29, 2024, and Korean Patent Application No. 10-2025-0080229, filed on Jun. 18, 2025, the disclosures of which are incorporated by reference herein in their entirety.

### TECHNICAL FIELD

The present disclosure relates to a method and apparatus for processing aperiodic channel state information reporting requests.

### BACKGROUND

The statements in this section merely provide background information related to the present disclosure and do not necessarily constitute prior art.

In mobile communication systems, carrier aggregation (CA) which utilizes multiple frequency bands simultaneously is used to support high-speed data transmission. A user equipment (UE) can receive communication services in parallel using one or more secondary component carriers (SCCs) in addition to a primary component carrier (PCC). Each secondary carrier is activated or deactivated according to instructions from a base station (BS).

Methods by which a BS receives channel state reports from a UE can be divided into periodic channel state information (CSI) reporting and aperiodic CSI reporting. Aperiodic CSI reporting requests involve a method in which a BS requests a CSI report from a UE by indicating a preset trigger state using downlink control information (DCI) at the required time.

However, according to 3GPP TS 38.214, if a secondary carrier for which reporting is requested is in an inactive state, channel state information reporting may not be performed, which may result in waste of physical downlink control channel (PDCCH) and physical uplink shared channel (PUSCH) resources.

### SUMMARY

An object of the present disclosure is to provide a method and apparatus for processing aperiodic channel state information (CSI) reporting requests to support carrier aggregation (CA). Specifically, the present disclosure primarily provides a method and apparatus for requesting a trigger-state-based aperiodic CSI report from a UE by activating or deactivating a secondary carrier configured for the UE based on trigger state information for aperiodic CSI reporting.

The technical objects of the present disclosure are not limited to those described above, and other technical objects not mentioned above may be understood clearly by those skilled in the art from the descriptions given below.

An embodiment of the present disclosure provides a method for processing an aperiodic channel state information (CSI) reporting request supporting carrier aggregation, performed by a base station, the method comprising: generating, for each carrier configured for a UE, a carrier-specific trigger state list including one or more trigger states associated with each carrier; identifying trigger states in which all associated carriers are in an active state as first trigger states, among trigger states included in a carrier-specific trigger state list of a carrier being a target of aperiodic channel state information reporting request; determining, among the first trigger states, a trigger state having a maximum number of associated carriers as a second trigger state; and setting the second trigger state in a CSI request field of downlink control information and transmitting the downlink control information to the UE.

Another embodiment of the present disclosure provides a base station configured to process an aperiodic channel state information (CSI) reporting request supporting carrier aggregation, the base station comprising: a transceiver; and at least one processor, wherein the at least one processor is operably coupled to the transceiver and is configured to perform: generating, for each carrier configured for a UE, a carrier-specific trigger state list including one or more trigger states associated with each carrier; identifying trigger states in which all associated carriers are in an active state as first trigger states, among trigger states included in a carrier-specific trigger state list of a carrier being a target of aperiodic channel state information reporting request; determining, among the first trigger states, a trigger state having a maximum number of associated carriers as a second trigger state; and setting the second trigger state in a CSI request field of downlink control information and transmitting the downlink control information to the UE.

According to an embodiment of the present disclosure, a BS can prevent a situation in which channel state information reporting is not performed due to an inactive carrier by considering the active state of all carriers associated with a trigger state to be indicated.

According to an embodiment of the present disclosure, waste of PDCCH and PUSCH resources can be reduced by preventing selection of a trigger state in which CSI reporting is not possible.

According to an embodiment of the present disclosure, a BS can determine a trigger state with the maximum number of associated carriers among trigger states and request a CSI report from a UE, thereby expanding the reception range of CSI.

According to an embodiment of the present disclosure, waste of radio resources can be reduced by collectively activating multiple secondary carriers configured for a UE based on trigger state information.

According to an embodiment of the present disclosure, waste of radio resources can be reduced by collectively deactivating multiple secondary carriers configured for a UE based on trigger state information.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a diagram illustrating a structure of a wireless communication system according to an embodiment of the present disclosure.

FIG. 2 is a diagram schematically illustrating a part of a procedure of data transmission and reception between a UE and a BS in a carrier aggregation environment according to an embodiment of the present disclosure.

FIG. 3 is a diagram illustrating a configuration of a BS apparatus for processing an aperiodic channel state information reporting request according to an embodiment of the present disclosure.

FIG. 4 is a flowchart illustrating a procedure for an aperiodic channel state information reporting request according to an embodiment of the present disclosure.

FIG. 5 is a flowchart illustrating a procedure when an activation request is generated for an inactive secondary carrier configured for a UE according to an embodiment of the present disclosure.

FIG. 6 is a flowchart illustrating a procedure when a deactivation request is generated for an active secondary carrier configured for a UE according to an embodiment of the present disclosure.

FIG. 7 is a diagram schematically illustrating a configuration of a BS according to an embodiment of the present disclosure.

FIG. 8 is a block diagram illustrating an exemplary computing device that may be used for implementing a method or an apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

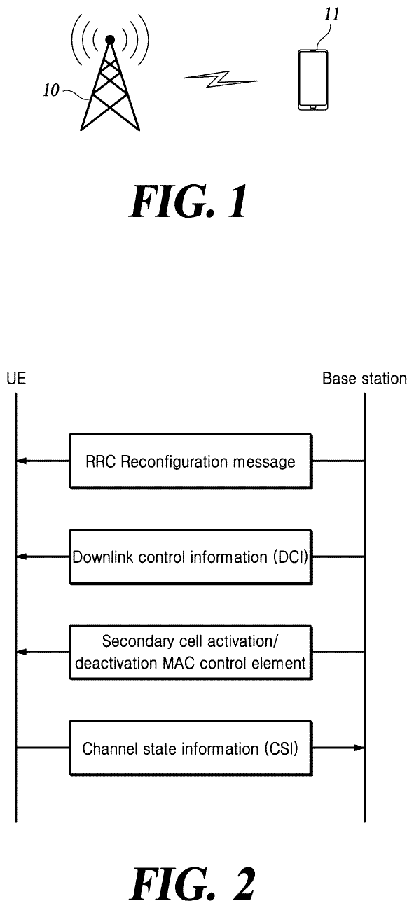

FIG. 1 is a diagram illustrating a structure of a wireless communication system according to an embodiment of the present disclosure.

Referring to FIG. 1, the wireless communication system may include a network-side apparatus 10 and a user equipment (UE) 11. The network-side apparatus 10 according to an embodiment of the present disclosure may be a base station (BS).

A method and apparatus for processing a channel state information reporting request according to an embodiment of the present disclosure may be used in the wireless communication system. The wireless communication system refers to a system that transmits and receives data using a wireless link between the network-side apparatus 10 and the UE 11. The wireless communication system may be defined according to the 3rd Generation Partnership Project (3GPP) standard and may include, for example, a fourth generation (LTE; Long Term Evolution) system, a fifth generation (NR; New Radio) system, or a subsequent evolved communication system. The wireless communication system may include a radio access network (RAN) and a core network (CN).

In this specification, the term “base station” may be used as a concept including an evolved Node Base Station (eNB) of an LTE system defined in the 3GPP standard or a next-generation Node Base Station (gNB) of a 5G NR system.

In this specification, the UE 11 refers to a user device that connects to a wireless communication system and performs data transmission and reception. According to an embodiment of the present disclosure, the UE 11 may be a mobile phone, a tablet computer, a laptop, an ultra-mobile personal computer (UMPC), a network computer, or a personal digital assistant (PDA).

The wireless communication system according to an embodiment of the present disclosure may support carrier aggregation (CA). Carrier aggregation is a technology for increasing data transmission speed by combining multiple frequency bands or multiple serving cells. In the wireless communication system supporting CA, the UE 11 can transmit and receive data using one primary component carrier (PCC) and one or more secondary component carriers (SCCs). In the wireless communication system supporting CA, the BS can control the activation state of the SCCs.

FIG. 2 is a diagram schematically illustrating a part of a procedure of data transmission and reception between a UE and a BS in a carrier aggregation environment according to an embodiment of the present disclosure.

Channel state information (CSI) is information that a UE measure the quality or state of a wireless channel and reports to a BS. CSI reporting methods can be divided into periodic CSI reporting and aperiodic CSI reporting. Aperiodic CSI reporting is a method in which a UE performs reporting at the request of a BS.

According to an embodiment of the present disclosure, a trigger state refers to logical state information preset by a BS for a UE to request aperiodic CSI reporting. The BS may configure a trigger state list for aperiodic CSI reporting by setting a CSI-AperiodicTriggerStateList to the UE using a radio resource control (RRC) layer message. Each trigger state included in the trigger state list may be associated with one or more reportConfigIds according to associatedReportConfigInfoList. The reportConfigId identifies CSI-ReportConfig configured in the RRC layer. The CSI-ReportConfig is applied based on the carrier configured in the carrier field. Channel measurement of the UE is performed based on the CSI-ResourceConfigId configured in the carrier.

The BS may instruct the UE to perform aperiodic CSI reporting by setting one of the trigger states included in the trigger state list in a CSI request field of downlink control information (DCI).

For example, trigger state #1 is associated with CSI-ReportConfigId #1 for reporting channel measurement information of a first serving cell (serving cell #1) of the UE and CSI-ReportConfigId #2 for reporting channel measurement information of a second serving cell (serving cell #2). When the BS sets trigger state #1 in the channel state information request field of downlink control information and transmits the same to in the UE, the UE performs CSI reporting including channel measurement information of the first serving cell and channel measurement information of the second serving cell according to trigger state #1 set in the channel state information request field.

According to 3GPP TS 38.214 (Release 15) Section 5.2.1.5.1, the UEs do not expect a CSI report to be triggered for an inactive downlink bandwidth part (DL BWP) in aperiodic CSI report triggering. For example, the first serving cell (serving cell #1) or the second serving cell (serving cell #2), which is the CSI report target carrier associated with trigger state #1, is in an inactive state. The BS sets trigger state #1 in the CSI request field of the DCI and transmits the same to the UE. Since the UE follows the regulations of 3GPP TS 38.214 (Release 15) Section 5.2.1.5.1, the UE does not perform CSI reporting for the serving cells associated with trigger state #1.

The bit size of the CSI request field included in the DCI is determined by reportTriggerSize (INTEGER 0 . . . 6), which is an RRC configuration parameter set in the UE. The reportTriggerSize defines the bit length of a trigger state identifier included in the CSI request field depending on the format of the DCI. When N is an integer value or equal to or greater than 0 and equal to or less than 6, and the value of reportTriggerSize is n, the maximum number of trigger states that can be indicated using the DCI is 2n−1. For example, when reportTriggerSize is set to the maximum value of 6, the BS can identify up to 63 (26-1) trigger states and indicate the same to the UE.

Referring to FIG. 2, the BS may transmit an RRCReconfiguration message, downlink control information (DCI), and a secondary cell activation/deactivation MAC control element (SCell Activation/Deactivation MAC CE) to the UE. The UE may transmit channel state information (CSI) to the BS.

The BS may set a reporting configuration for CSI measurement by transmitting a radio resource control (RRC) layer RRC reconfiguration message to the UE. The RRC reconfiguration message is transmitted to the UE on a physical downlink shared channel (PDSCH). The RRC reconfiguration message may include CSI-MeasConfig. CSI-MeasConfig may configure a trigger state list for aperiodic CSI reporting triggering using CSI-AperiodicTriggerStateList.

To request CSI reporting from the UE, the BS may set a trigger state index in the CSI request field of DCI and transmit the DCI to the UE. In other words, the UE may receive the DCI from the BS. The DCI is transmitted to the UE on a physical downlink control channel (PDCCH). The UE measures CSI according to CSI-ReportConfig and carrier configuration included in the trigger state.

To activate an inactive secondary carrier configured for the UE, the BS may transmit an SCell Activation/Deactivation MAC CE including an activation instruction to the UE. That is, the UE may receive the SCell Activation/Deactivation MAC CE including the activation instruction from the BS. The SCell Activation/Deactivation MAC CE is included in a medium access control protocol data unit (MAC PDU) and transmitted to the UE on a PDSCH.

To deactivate an active secondary carrier configured for the UE, the BS may transmit an SCell Activation/Deactivation MAC CE including a deactivation instruction to the UE. That is, the UE may receive the SCell Activation/Deactivation MAC CE including the deactivation instruction from the BS.

In response to a CSI reporting request, the UE may generate CSI and transmit the same to the BS. CSI in response to an aperiodic CSI reporting request is transmitted to the BS on a physical uplink shared channel (PUSCH).

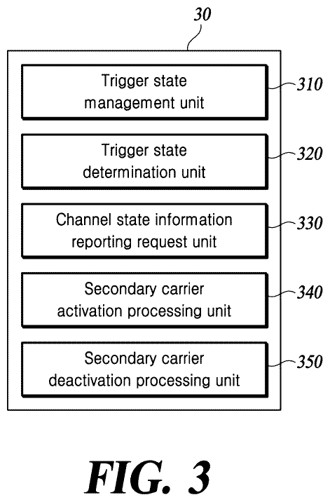

FIG. 3 is a diagram illustrating a configuration of a BS apparatus for processing an aperiodic channel state information reporting request according to an embodiment of the present disclosure.

Referring to FIG. 3, a BS apparatus 30 according to an embodiment of the present disclosure may include a trigger state management unit 310, a trigger state determination unit 320, a channel state information reporting request unit 330, a secondary carrier activation processing unit 340, and a secondary carrier deactivation processing unit 350.

The trigger state management unit 310 configures a trigger state list for aperiodic channel state information reporting by setting a CSI-AperiodicTriggerStateList. The trigger state management unit 310 generates and manages a carrier-specific trigger state list for each carrier configured for a UE. The carrier-specific trigger state list includes one or more trigger states associated with each carrier among trigger state lists configured according to the CSI-AperiodicTriggerStateList.

In this specification, the expression “a carrier and a trigger state are associated” means that at least one CSI-ReportConfig included in the trigger state is configured for the carrier. The carrier-specific trigger state list is configured for all carriers configured in the UE. The configuration within the BS apparatus 30 and the UE may identify the trigger state associated with each carrier based on the carrier-specific trigger state list. The carrier-specific trigger state list may be a list in which a trigger state associated with each carrier is mapped to each carrier.

The trigger state determination unit 320 determines a trigger state for requesting aperiodic channel state information reporting for an active carrier configured in the UE. According to 3GPP TS 38.214 (Release 15) Section 5.2.1.5.1, channel state information reporting is not performed for an inactive secondary carrier. The trigger state determination unit 320 identifies a trigger state in which all carriers associated with the trigger state are active among the trigger states included in the carrier-specific trigger state list of a carrier that is the target of the aperiodic channel state information reporting request as a first trigger state. For example, a trigger state associated with an inactive carrier for which channel state information reporting is not expected to be performed is not identified as the first trigger state. The number of first trigger states may be one or more. The trigger state determination unit 320 determines a first trigger state having a maximum number of carriers associated with the first trigger state as a second trigger state among the first trigger states. For example, the second trigger state may be a trigger state for which channel state information reporting is expected to be performed for the maximum number of carriers among a plurality of first trigger states.

When an aperiodic channel state information reporting request is generated for an active carrier configured for the UE, the channel state information reporting request unit 330 requests or triggers channel state information reporting to the UE. The channel state information reporting request unit 330 sends a request for determining a second trigger state for the active carrier that is the target of reporting request to the trigger state determination unit 320. The channel state information reporting request unit 330 sets the second trigger state determined by the trigger state determination unit 320 in the CSI request field of downlink control information (DCI). The channel state information reporting request unit 330 transmits the DCI in which the second trigger state has been set to the UE on a PDCCH. The channel state information reporting request unit 330 requests channel state information reporting of the UE by transmitting the DCI to the UE.

When an activation request is generated for an inactive secondary carrier configured for the UE, the secondary carrier activation processing unit 340 instructs the UE to activate the inactive secondary carrier. The secondary carrier activation processing unit 340 identifies, as a third trigger state, a trigger state having a minimum number of inactive carriers associated with the trigger state among the trigger states included in the carrier-specific trigger state list of the secondary carrier for which activation is requested. The number of third trigger states may be one or more. The secondary carrier activation processing unit 340 determines, as a fourth trigger state, a third trigger state having a maximum number of carriers associated with the third trigger state among the third trigger states. For example, the fourth trigger state may be a trigger state that is expected to be determined as a second trigger state by the trigger state determination unit 320 after activation processing among the third trigger states. The secondary carrier activation processing unit 340 instructs activation for all inactive secondary carriers associated with the fourth trigger state. The secondary carrier activation processing unit 340 instructs activation by transmitting an SCell Activation/Deactivation MAC CE including an activation instruction for each secondary carrier to the UE. The UE receives the SCell Activation/Deactivation MAC CE including the activation instruction and switches all inactive secondary carriers associated with the fourth trigger state to an active state.

When a deactivation request is generated for an active secondary carrier configured for the UE, the secondary carrier deactivation processing unit 350 instructs the UE to deactivate the active secondary carrier. The secondary carrier deactivation processing unit 350 identifies, as a fifth trigger state list, a trigger state list excluding the carrier-specific trigger state list of the secondary carrier for which deactivation is requested from the trigger state lists configured for the UE. The fifth trigger state list may be a trigger state list configured to include one or more trigger states. The secondary carrier deactivation processing unit 350 determines a set of carriers associated with each trigger state included in the fifth trigger state list. For example, the carriers associated with each trigger state included in the fifth trigger state list are not associated with the trigger state associated with the secondary carrier for which deactivation is requested. The secondary carrier deactivation processing unit 350 instructs deactivation for secondary carriers that are not included in the set of carriers associated with each trigger state included in the fifth trigger state list among all active secondary carriers configured for the UE. The secondary carrier deactivation processing unit 350 instructs deactivation by transmitting an SCell Activation/Deactivation MAC CE including a deactivation instruction for each secondary carrier to the UE. The UE receives the SCell Activation/Deactivation MAC CE including the deactivation instruction and switches the active secondary carrier to an inactive state.

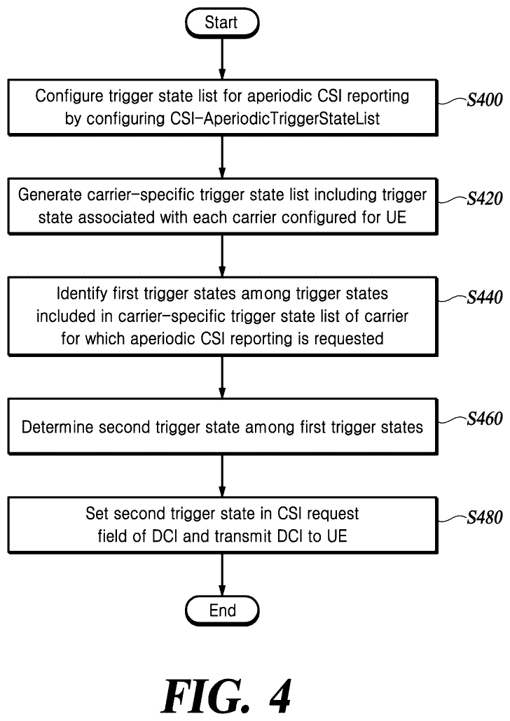

FIG. 4 is a flowchart illustrating a procedure for requesting aperiodic channel state information reporting according to an embodiment of the present disclosure.

Referring to FIG. 4, a BS configures a CSI-AperiodicTriggerStateList for a UE using an RRC reconfiguration message. By configuring the CSI-AperiodicTriggerStateList, the BS may configure a trigger state list for aperiodic channel state reporting (S400). After configuring the trigger state list, the BS generates a carrier-specific trigger state list by matching trigger states associated with each carrier configured for the UE (S420). The process of generating the carrier-specific trigger state list is a process of generating a mapping table from each carrier and the trigger states associated with each carrier. After generating the carrier-specific trigger state list, the BS identifies a first trigger state among trigger states included in a carrier-specific trigger state list of a carrier for which aperiodic CSI reporting has been requested (S440). The first trigger state is a trigger state in which all associated carriers are active among the trigger states included in the carrier-specific trigger state list of the carrier for which aperiodic CSI reporting has been requested. After identifying the first trigger state, the BS determines a second trigger state from among one or more first trigger states (S460). The second trigger state is a trigger state in which the number of carriers associated with the first trigger state is the maximum among one or more first trigger states. After determining the second trigger state, the BS sets the determined second trigger state in the CSI request field of downlink control information (DCI) and transmits the DCI to the UE (S480). By transmitting the DCI to the UE, the BS requests a CSI report from the UE depending on the trigger state.

Table 1 shows an example of a list of trigger states set according to the CSI-AperiodicTriggerStateList and associated carriers.

TABLE 1

| Trigger | |
|---|---|
| state | Associated carrier |
| S1 | PCC |
| S2 | SCC 1, SCC 2, SCC 3, SCC 4 |
| S3 | SCC 5, SCC 6, SCC 7 |
| S4 | PCC, SCC 1, SCC 2, SCC 3, SCC 4, SCC 5, SCC 6, SCC 7 |

Table 2 shows an example of a list of carriers and associated trigger states generated for each carrier.

TABLE 2

| Carrier | Associated trigger state |
|---|---|
| PCC | S1, S4 |
| SCC 1, SCC 2, SCC 3, SCC 4 | S2, S4 |
| SCC 5, SCC 6, SCC 7 | S3, S4 |

Referring to Table 1, trigger state S1 is associated with a primary component carrier (PCC). Trigger state S2 is associated with a secondary component carrier (SCC) 1, SCC 2, SCC 3, and SCC 4. Trigger state S3 is associated with SCC 5, SCC 6, and SCC 7. Trigger state S4 is associated with PCC, SCC 1, SCC 2, SCC 3, SCC 4, SCC 5, SCC 6, and SCC 7. Referring to Table 2, PCC is associated with trigger state S1 and trigger state S4. SCC 1, SCC 2, SCC 3, and SCC 4 are associated with trigger states S2 and S4. SCC 5, SCC 6, and SCC 7 are associated with trigger state S3 and trigger state S4. PCC is always active. In an embodiment of the present disclosure, SCC 1, SCC 2, SCC 3, SCC 4, SCC 5, SCC 6, and SCC 7 configured for the UE may all be in an active state. When an aperiodic channel state information reporting request for SCC 1 configured for the UE is generated, the BS identifies a first trigger state among the trigger states included in the carrier-specific trigger state list of SCC 1 (S440). The trigger states included in the carrier-specific trigger state list of SCC 1 are trigger state S2 and trigger state S4. Since all carriers SCC 1 to SCC 4 associated with trigger state S2 are in an active state, trigger state S2 is a first trigger state. Since all carriers PCC and SCC 1 to SCC 7 associated with trigger state S4 are in an active state, trigger state S4 is a first trigger state. The BS determines, as a second trigger state, a trigger state having the maximum number of carriers connected to the trigger state between trigger state S2 and trigger state S4 (S460). The BS determines trigger state S4 as the second trigger state, sets trigger state S4 in the CSI request field of downlink control information, and transmits the downlink control information to the UE (S480).

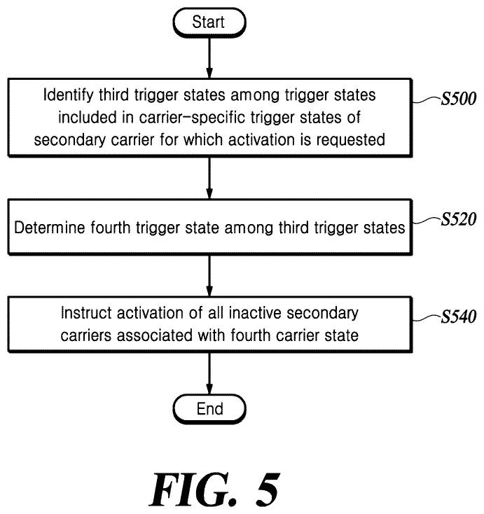

FIG. 5 is a flowchart illustrating a procedure when an activation request is generated for an inactive secondary carrier configured for a UE according to an embodiment of the present disclosure.

Referring to FIG. 5, when an activation request is generated for an inactive secondary carrier configured for a UE, a BS identifies a third trigger state among the trigger states included in the carrier-specific trigger state list of the secondary carrier for which activation is requested (S500). The third trigger state is a trigger state having the minimum number of inactive carriers associated with the trigger state among the trigger states included in the carrier-specific trigger state list of the secondary carrier for which activation is requested. After identifying the third trigger state, the BS determines a fourth trigger state among one or more third trigger states (S520). The fourth trigger state is a trigger state having the maximum number of carriers associated with the third trigger state among the third trigger states. After determining the fourth trigger state, the BS instructs the UE to activate all inactive secondary carriers associated with the fourth trigger state (S540). The BS may instruct activation of the secondary carriers by configuring a secondary cell activation/deactivation MAC control element and transmitting the same to the UE.

Referring to Tables 1 and 2, in an embodiment of the present disclosure, SCC 1, SCC 2, SCC 3, SCC 4, SCC 5, SCC 6, and SCC 7 configured for the UE may all be inactive. When an activation request is generated for SCC 1 configured for the UE, the BS identifies a third trigger state among the trigger states included in the carrier-specific trigger state list of SCC 1 (S500). The trigger states included in the carrier-specific trigger state list of SCC 1 are trigger state S2 and trigger state S4. Between trigger states S2 and S4, trigger state S2 which has the minimum number of inactive carriers associated with the trigger state is a third trigger state. Trigger state S4 is not a third trigger state. The BS determines trigger state S2, which is the third trigger state, as a fourth trigger state (S520). The BS instructs the UE to activate SCC 1, SCC 2, SCC 3, and SCC 4, which are in an inactive state and associated with trigger state S2 (S540). The BS may instruct the UE to activate each secondary carrier by transmitting a secondary cell activation/deactivation MAC control element including an activation instruction for each of SCC 1, SCC 2, SCC 3, and SCC 4 to the UE.

Referring to Tables 1 and 2, in another embodiment of the present disclosure, SCC 5, SCC 6, and SCC 7 configured for the UE may be in an inactive state. When an activation request is generated for SCC 5 configured for the UE, the BS identifies a third trigger state among the trigger states included in the carrier-specific trigger state list of SCC 5 (S500). The trigger states included in the carrier-specific trigger state list of SCC 5 are trigger state S3 and trigger state S4. Trigger state S3 and trigger state S4, which have the minimum number of inactive carriers associated with the trigger states, are third trigger states. The BS determines trigger state S4, which has the maximum number of carriers associated with the trigger state, as a fourth trigger state (S520). The BS instructs the UE to activate SCC 5, SCC 6, and SCC 7 in an inactive state associated with trigger state S4 (S540). The BS may instruct the UE to activate each secondary carrier by transmitting a secondary cell activation/deactivation MAC control element including an activation instruction for each of SCC 5, SCC 6, and SCC 7.

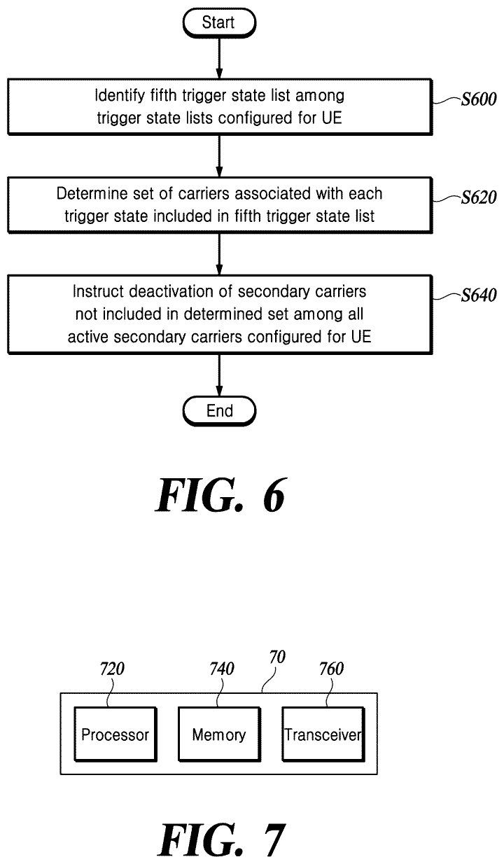

FIG. 6 is a flowchart illustrating a procedure when a deactivation request is generated for an inactive secondary carrier configured for a UE according to an embodiment of the present disclosure.

Referring to FIG. 6, when a deactivation request is generated for an inactive secondary carrier configured for the UE, the BS identifies, as a fifth trigger state list, a trigger state list excluding the carrier-specific trigger state list of the secondary carrier for which deactivation is requested from trigger state lists configured for the UE (S600). After identifying the fifth trigger state list, the BS determines a set of carriers associated with each trigger state included in the fifth trigger state list (S620). After determining the set, the BS instructs the UE to deactivate secondary carriers not included in the determined set among all active secondary carriers configured for the UE (S640). The BS may instruct the UE to deactivate the secondary carriers by configuring a secondary cell activation/deactivation MAC control element and transmitting the same to the UE.

Referring to Tables 1 and 2, in an embodiment of the present disclosure, SCC 1, SCC 2, SCC 3, SCC 4, SCC 5, SCC 6, and SCC 7 configured for the UE may all be in an active state. When a deactivation request is generated for SCC 1 configured for the UE, the BS identifies, as a fifth trigger state list, a trigger state list excluding the carrier-specific trigger state list of SCC 1 from trigger state lists configured for the UE (S600). Since trigger state S2 and trigger state S4 are excluded from trigger states S1 to S4, a trigger state list including trigger state S1 and trigger state S3 is identified as the fifth trigger state list. The BS determines a set of carriers associated with trigger state S1 and carriers associated with trigger state S3 (S620). The determined set of carriers includes a PCC associated with trigger state S1. The determined set of carriers includes SCC 5, SCC 6, and SCC 7 associated with trigger state S3. The BS instructs the UE to deactivate secondary carriers, excluding PCC and SCCs 5 through 7, among PCC and SCCs 1 through 7 (S640). That is, the BS instructs the UE to deactivate SCC 1, SCC 2, SCC 3, and SCC 4. The BS may instruct the UE to deactivate each secondary carrier by transmitting a secondary cell activation/deactivation MAC control element including a deactivation instruction for each of SCC 1, SCC 2, SCC 3, and SCC 4 to the UE.

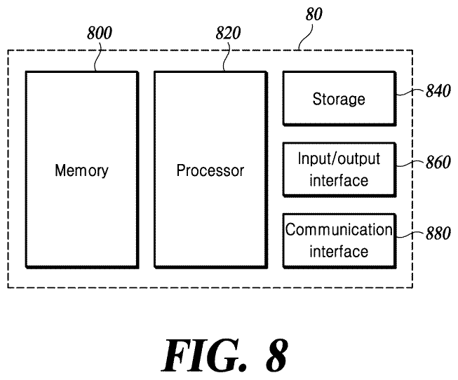

FIG. 7 is a diagram schematically illustrating a configuration of a BS according to an embodiment of the present disclosure.

Referring to FIG. 7, the BS 70 may include some or all of at least one processor 720, a memory 740, and a transceiver 760 connected to a network and performing communication. The at least one processor 720 may be operably coupled to the transceiver 760.

The BS 70 may further include additional components, such as a timer, a clock generator, a power supply, and an interface circuit. Additional components within the BS 70 may be provided as part of the hardware configuration for processing aperiodic channel state information reporting requests.

The processor 720 may include at least one core capable of executing at least one instruction. The processor 720 may execute instructions stored in the memory 740. The processor 720 may be a single processor or multiple processors.

The memory 740 may store a program that causes the processor 720 to perform methods or operations according to various embodiments of the present disclosure. For example, the program may include multiple instructions executable by the processor 720, and the above-described methods or operations may be performed by the processor 720 executing the multiple instructions. The memory 740 may be a single memory or multiple memories.

The transceiver 760 is operably coupled to an antenna and may transmit/receive signals for wireless communication to/from a UE and other BSs. The transceiver 760 may include some or all of an RF front-end module, a baseband processing unit, an amplifier, a filter, a modulator, and a demodulator.

FIG. 8 is a block diagram illustrating an exemplary computing device that may be used for implementing a method or an apparatus according to the present disclosure.

The computing device 80 may include all or part of a memory 800, a processor 820, a storage 840, an input/output interface 860, and a communication interface 880. The computing device 80 may be a stationary computing device, such as a desktop computer or a server, or a mobile computing device, such as a laptop computer or a smart phone. The computing device 80 may include a specialized hardware accelerator capable of processing operations of an artificial intelligence model in an efficient manner. For example, the computing device 80 may include a graphic processing unit (GPU), a tensor processing unit (TPU), or a neural processing unit (NPU).

The memory 800 may store a program that enables the processor 820 to perform methods or operations according to various embodiments of the present disclosure. For example, a program may include a plurality of instructions executable by the processor 820, and the methods or operations described above may be performed by executing the plurality of instructions by the processor 820. The memory 800 may consist of a single memory or a plurality of memories. In this case, information required to perform the methods or operation according to various embodiments of the present disclosure may be stored in a single memory or distributed across a plurality of memories. When the memory 800 is composed of a plurality of memories, the plurality of memories may be physically separated. The memory 800 may include at least one of volatile memory and non-volatile memory. Volatile memory includes Static Random Access Memory (SRAM) or Dynamic Random Access Memory (DRAM), while non-volatile memory includes flash memory.

The processor 820 may include at least one core capable of executing at least one instruction. The processor 820 may execute instructions stored in the memory 800. The processor 820 may consist of a single processor or a plurality of processors.

The storage 840 maintains stored data even if power supplied to the computing device 80 is cut off. For example, the storage 840 may include non-volatile memory or may include a storage medium such as a magnetic tape, an optical disk, or a magnetic disk. A program stored in the storage 840 may be loaded into the memory 800 before being executed by the processor 820. The storage 840 may store files written in a program language, and a program created from the files by a compiler may be loaded into the memory 800. The storage 840 may store data to be processed by the processor 820 and/or data processed by the processor 820.

The input/output interface 860 may provide an interface with an input device such as a keyboard or a mouse and/or an output device such as a display device or a printer. The user may trigger execution of a program by the processor 820 through the input device and/or check the processing results of the processor 820 through the output device.

The communication interface 880 may provide access to an external network. The computing device 80 may communicate with other devices through the communication interface 880.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed:

1. A method for processing an aperiodic channel state information (CSI) reporting request supporting carrier aggregation, performed by a base station, the method comprising:
generating, for each carrier configured for a UE, a carrier-specific trigger state list including one or more trigger states associated with each carrier;
identifying trigger states in which all associated carriers are in an active state as first trigger states, among trigger states included in a carrier-specific trigger state list of a carrier being a target of aperiodic channel state information reporting request;
determining, among the first trigger states, a trigger state having a maximum number of associated carriers as a second trigger state; and
setting the second trigger state in a CSI request field of downlink control information and transmitting the downlink control information to the UE.

2. The method of claim 1, further comprising:
if an activation request is generated for an inactive secondary carrier configured for the UE,
identifying trigger states having a minimum number of associated inactive carriers as third trigger states, among trigger states included in a carrier-specific trigger state list of the secondary carrier for which activation is requested;
determining, among the third trigger states, a trigger state having a maximum number of associated carriers as a fourth trigger state; and
instructing activation of all inactive secondary carriers associated with the fourth trigger state.

3. The method of claim 2, wherein the instructing activation comprises configuring a secondary cell activation/deactivation MAC control element and transmitting the control element to the UE.

4. The method of claim 1, further comprising:
if a deactivation request is generated for an active secondary carrier configured for the UE,
identifying, as a fifth trigger state list, a trigger state list excluding a carrier-specific trigger state list of a secondary carrier for which deactivation is requested from trigger state lists configured for the UE;
determining a set of carriers associated with each trigger state included in the fifth trigger state list; and
instructing deactivation of secondary carriers not included in the set among all active secondary carriers configured for the UE.

5. The method of claim 4, wherein the instructing deactivation comprises configuring a secondary cell activation/deactivation MAC control element and transmitting the control element to the UE.

6. A base station configured to process an aperiodic channel state information (CSI) reporting request supporting carrier aggregation, the base station comprising:
a transceiver; and
at least one processor,
wherein the at least one processor is operably coupled to the transceiver and is configured to perform:
generating, for each carrier configured for a UE, a carrier-specific trigger state list including one or more trigger states associated with each carrier;
identifying trigger states in which all associated carriers are in an active state as first trigger states, among trigger states included in a carrier-specific trigger state list of a carrier being a target of aperiodic channel state information reporting request;
determining, among the first trigger states, a trigger state having a maximum number of associated carriers as a second trigger state; and
setting the second trigger state in a CSI request field of downlink control information and transmitting the downlink control information to the UE.

7. The base station of claim 6, wherein the processor is configured to further perform:
if an activation request is generated for an inactive secondary carrier configured for the UE,
identifying trigger states having a minimum number of associated inactive carriers as third trigger states, among trigger states included in a carrier-specific trigger state list of the secondary carrier for which activation is requested;
determining, among the third trigger states, a trigger state having a maximum number of associated carriers as a fourth trigger state; and
instructing activation of all inactive secondary carriers associated with the fourth trigger state.

8. The base station of claim 7, wherein the instructing activation comprises configuring a secondary cell activation/deactivation MAC control element and transmitting the control element to the UE.

9. The base station of claim 6, wherein the processor is configured to further perform:
if a deactivation request is generated for an active secondary carrier configured for the UE,
identifying, as a fifth trigger state list, a trigger state list excluding a carrier-specific trigger state list of a secondary carrier for which deactivation is requested from trigger state lists configured for the UE;
determining a set of carriers associated with each trigger state included in the fifth trigger state list; and
instructing deactivation of secondary carriers not included in the set among all active secondary carriers configured for the UE.

10. The base station of claim 9, wherein the instructing deactivation comprises configuring a secondary cell activation/deactivation MAC control element and transmitting the control element to the UE.
